(19) United States
(12) Patent Application Publication
(10) Pub. No.: US 2005/0198067 A1
(43) Pub. Date: Sep. 8, 2005

(54) Multi-resolution feature extraction for video abstraction

(76) Inventor: Casper Liu, Taipei (TW)

Correspondence Address: BIRCH STEWART KOLASCH & BIRCH, PO BOX 747, FALLS CHURCH, VA, 22040-0747, US

(21) Appl. No.: 10/792,823

(22) Filed: Mar. 5, 2004

(51) Int. Cl. G06F 17/00; G06K 9/34; G06K 9/60; G06K 9/36

(52) U.S. Cl. 707/104.1; 382/305; 382/190; 382/276; 382/173; 707/101

(57) ABSTRACT

A method for feature extraction. At least a raw image of a frame in a video sequence is stored in a storage area. A request is made for an image of the frame having a desired attribute. In response to the request, one of the images of the frame having the desired attribute in the storage area is returned if possible; otherwise, an image having the desired attribute, which is transformed from one of the images of the frame in the storage area, is returned and added the storage area. A value of a feature of the frame is calculated using the returned image.

### BACKGROUND OF THE INVENTION

1. Field of the Invention

The present invention relates to video abstraction and particularly to a method of video abstraction adopting multi-resolution feature extraction.

2. Description of the Prior Art

Digital video is an emerging force in today's computer and telecommunication industries. The rapid growth of the Internet, in terms of both bandwidth and the number of users, has pushed all multimedia technology forward including video streaming. Continuous hardware developments have reached the point where personal computers are powerful enough to handle the high storage and computational demands of digital video applications. DVD, which delivers high quality digital video to consumers, is rapidly penetrating the market. Moreover, the advances in digital cameras and camcorders have made it quite easy to capture a video and then load it into a computer in digital form. Many companies, universities and even ordinary families already have large repositories of videos both in analog and digital formats, such as the broadcast news, training and education videos, advertising and commercials, monitoring, surveying and home videos. All of these trends are indicating a promising future for the world of digital video.

The fast evolution of digital video has brought many new applications and consequently, research and development of new technologies, which will lower the costs of video archiving, cataloging and indexing, as well as improve the efficiency, usability and accessibility of stored videos are greatly needed. Among all possible research areas, one important topic is how to enable a quick browse of a large collection of video data and how to achieve efficient content access and representation. To address these issues, video abstraction techniques have emerged and have been attracting more research interest in recent years.

Video abstraction, as the name implies, is a short summary of the content of a longer video document. Specifically, a video abstract is a sequence of still or moving images representing the content of a video in such a way that the target party is rapidly provided with concise information about the content while the essential message of the original is well preserved.

Theoretically a video abstract can be generated both manually and automatically, but due to the huge volumes of video data and limited manpower, it's getting more and more important to develop fully automated video analysis and processing tools so as to reduce the human involvement in the video abstraction process.

There are two fundamentally different kinds of abstracts: still- and moving-image abstracts. The still-image abstract, also known as a static storyboard, is a small collection of salient images extracted or generated from the underlying video source. The moving-image abstract, also known as moving storyboard, or multimedia summary, consists of a collection of image sequences, as well as the corresponding audio abstract extracted from the original sequence and is thus itself a video clip but of considerably shorter length.

A still-image abstract can be built much faster, since generally only visual information is utilized and no handling of audio and textual information is needed. Therefore, once composed, it is displayed more easily since there are no timing or synchronization issues. Moreover, more salient images such as mosaics could be generated to better represent the underlying video content instead of directly sampling the video frames. Besides, the temporal order of all extracted representative frames can be displayed in a spatial order so that the users are able to grasp the video content more quickly. Finally, all extracted stills could be printed out very easily when needed.

There are also advantages using moving-image abstract. Compared to a still-image abstract, it makes much more sense to use the original audio information since sometimes the audio track contains important information such as those in education and training videos. Besides, the possibly higher computational effort during the abstracting process pays off during the playback time: it's usually more natural and more interesting for users to watch a trailer than watching a slide show, and in many cases, the motion is also information-bearing.

Muvee autoProducer, Roxio VideoWave and ACD VideoMagic are well known software applications featuring automatic video abstraction. They adopt Muvee's auto editing kernel technology to analyze a video clip. Features in the video clip are extracted, such as shot boundaries, low-quality material, the presence of human faces, and the direction and amount of motion. Representative frames or scenes are identified accordingly and an abstract composed thereof is generated.

Feature extraction is a critical step for video abstraction. New features must be developed in order to accurately map human cognition into the automated abstraction process. There may be different requirements for extraction of different features, on a particular attribute, such as resolution, of the processed image.

However, the conventional video abstraction techniques show less efficiency in feature extraction. The extraction procedure must include a step of transforming the image of the processed frame to one conforming with a corresponding requirement for each feature. Even if the same image transformation step is adopted for two or more features, it must be iterated for each. Besides, inclusion of the image transformation step in the extraction procedure complicates development of new features.

### SUMMARY OF THE INVENTION

The object of the present invention is to provide a method of video abstraction adopting multi-resolution feature extraction, wherein the working image conforming with a corresponding requirement for extraction of a feature is obtained only by making a request to an image pool manager, rather than by the extraction procedure itself.

The present invention provides a method for feature extraction including the steps of storing into a storage area at least a raw image of a frame in a video sequence, making a request for an image of the frame having a desired attribute, in response to the request, if possible, returning one of the images of the frame having the desired attribute in the storage area, otherwise, returning and adding the storage area an image having the desired attribute, which is transformed from one of the images of the frame in the storage area, and calculating a value of a feature of the frame using the returned image.

The present invention further provides a method for video abstraction including the steps of a) capturing one of the frames from a video sequence, b) applying scene detection to the captured frame, c) extracting features of the captured frame by the steps of c1) storing a raw image of the captured frame in a storage area, c2) for a selected one of the features, making a request for an image of the captured frame having a desired attribute, c3) in response to the request, if possible, returning one of images of the captured frame having the desired attribute in the storage area, otherwise, returning and adding into the storage area an image having the desired attribute, which is transformed from one of the images of the captured frame in the storage area, c4) calculating a value of the selected feature for the captured frame using the returned image, and c5) repeating the steps c2˜c4 until all the features are selected, d) repeating the steps a˜c until a transition from a current to a next scene is detected in the step b or all the frames are captured, e) calculating a score of the current scene using the values of the features of the frames therein, f) repeating the steps a˜e until all the frames are captured, and g) selecting the scenes according to the scores thereof and composing the selected scenes to yield an abstraction result.

The present invention also provides another method for video abstraction including the steps of a) capturing one of the frames from a video sequence, b) applying scene detection to the captured frame, c) extracting a first feature of the captured frame by the steps of c0) implementing steps c1˜c4 only if the captured frame is determined as a representative frame according to the scene detection result, otherwise, setting the value of the first feature of the captured frame the same as that of a representative frame previously determined, c1) storing a raw image of the captured frame in a storage area, c2) making a request for an image of the captured frame having a first desired attribute, c3) in response to the request, if possible, returning one of images of the captured frame having the first desired attribute in the storage area, otherwise, returning and adding the storage area an image having the first desired attribute, which is transformed from one of the images of the captured frame in the storage area, and c4) calculating a value of the first feature for the captured frame using the returned image, d) extracting a second feature of the captured frame by the steps of d0) storing into the storage area two raw images respectively of a previous and the currently captured frame, d1) making a request for two images respectively of the previous and currently captured frames having a second desired attribute, and d2) in response to the request and for each of the two requested images, if possible, returning one of images of the corresponding frame having the second desired attribute in the storage area, otherwise, returning and adding the storage area an image having the second desired attribute, which is transformed from one of the images of the corresponding frame in the storage area, and d3) calculating a value of the second feature for the captured frame using the two returned images, e) repeating the steps a˜d until a transition from a current to a next scene is detected in the step b or all the frames are captured, f) calculating a score of the current scene using the values of the features of the frames therein, g) repeating the steps a˜f until all the frames are captured, and h) selecting the scenes according to the scores thereof and composing the selected scenes to yield an abstraction result.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a flowchart of a method for video abstraction according to one embodiment of the invention.

FIG. 2 is a flowchart of a method for the feature extraction shown in FIG. 1 according to one embodiment of the invention.

### DETAILED DESCRIPTION OF THE INVENTION

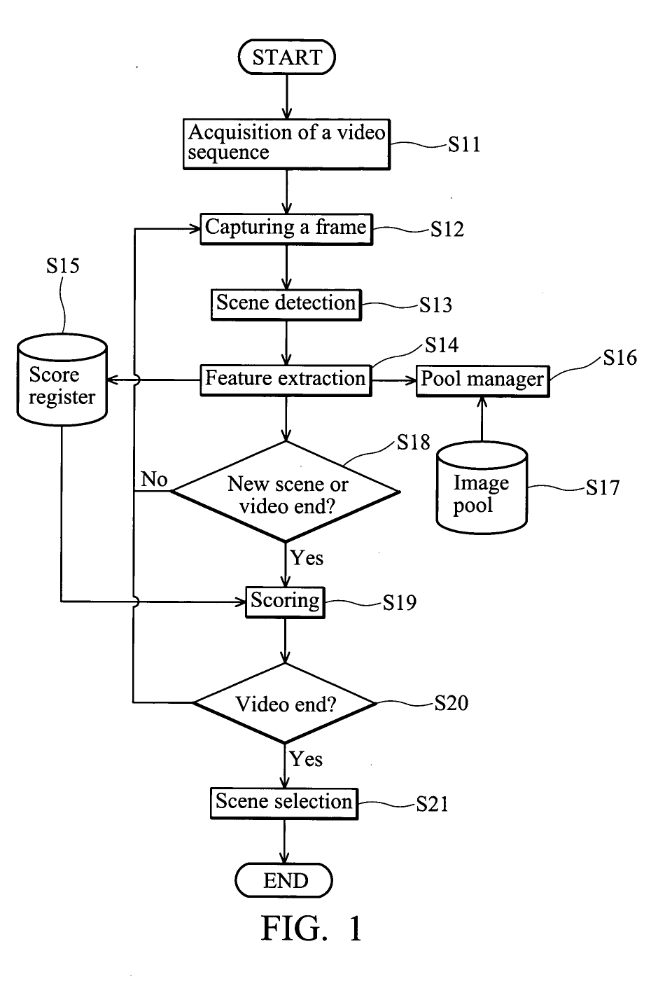

FIG. 1 is a flowchart of a method for video abstraction according to one embodiment of the invention.

In step S11, a video sequence is acquired. For example, the video sequence is composed of 4 different scenes, and has 1800 frames with a resolution of 720×480 and a length of 1 minute at a frame rate of 30 fps.

In step S12, a first frame is captured from the video sequence.

In step S13, scene detection is applied to the currently captured frame.

In step S14, values or scores of multiple features, such as averaged color, averaged brightness, skin ratio, stability, motion activity and color difference, are extracted from the captured frame and stored into a score register S15. Additionally, working images of the captured frame essential to feature extraction are derived from an image pool manager S16. The image pool manager S16 receives requests from the extraction procedures of the 6 features. Once a request is received, the image manager S16 searches for the requested image within an image pool S17 (a temporary storage area) wherein a raw image of the current frame is initially stored. If the requested image is found, it is returned; otherwise, the image pool manager S16 selects and transforms an image in the image pool S17 to the requested image. The image pool manager S16 also stores the returned working images into the image pool S17 so that the image transformation needs not to be iterated if a request for the same image is received later.

In step S18, it is determined whether the currently captured frame is a first frame of a following scene according to the scene detection result, or the end of the video sequence. If so, the flow goes to step S19; otherwise, the flow goes back to step S12 wherein a next frame is captured.

In step S19, the scores or values of the 6 features of all the frames in the current scene are derived from the score register S15. For each feature, an overall score of the current scene is calculated using the scores or values of the feature of all the frames in the current scene. For example, 6 overall scores respectively of averaged color, averaged brightness, skin ratio, stability, motion activity and color difference are calculated.

In step S20, it is determined whether the currently captured frame is the end of the video sequence. If so, the flow goes to step S21; otherwise, the flow goes back to step S12 wherein a next frame is captured.

In step S21, the scenes are selected according to the overall scores thereof and an abstraction result is yielded by composing the selected scenes. For example, the first and third scenes of the video sequence are selected since they had a high overall score in skin ratio, stability and motion activity which are weighted more heavily than the other 3 features, hence the abstraction result is composed thereof.

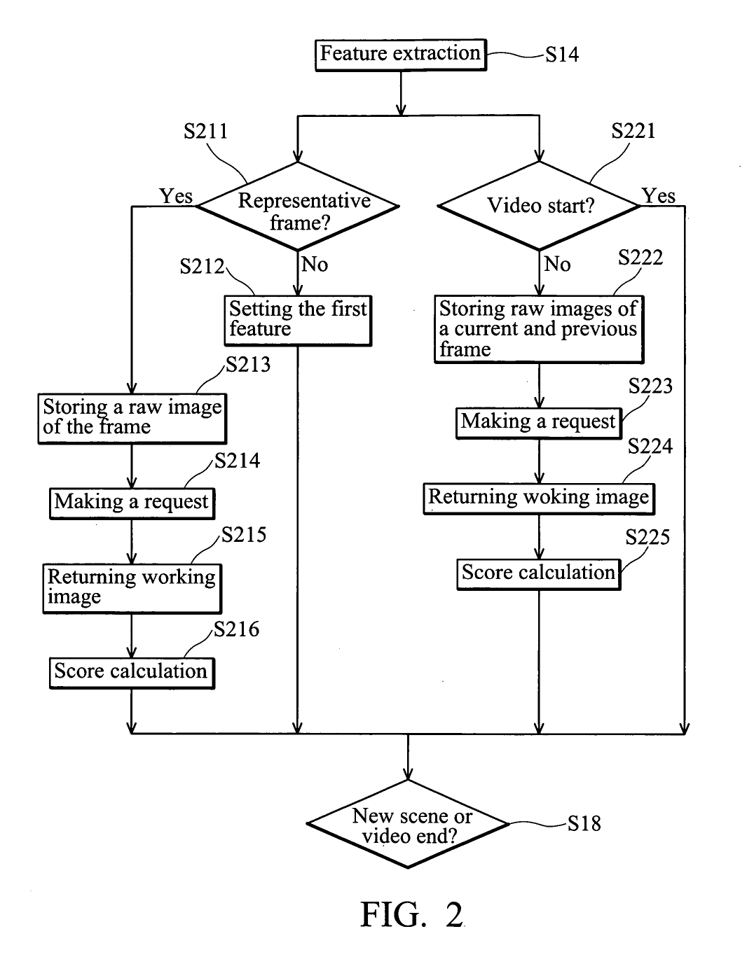

FIG. 2 is a flowchart of a method for the feature extraction shown in FIG. 1 according to one embodiment of the invention.

In step 211, for extraction of a first feature such as averaged color, averaged brightness or skin ratio, it is determined according to the scene detection result whether the currently captured frame is a representative frame. If so, the flow goes to step S213; otherwise, the flow goes to step S212.

In step 212, the value or score of the first feature is set equal to that of a previous representative frame.

In step 213, a raw image of the current frame is stored into the image pool S17.

In step S214, the extraction procedure of the first feature makes a request for a working image with a first desired attribute, such as a resolution of 360×240.

In step S215, in response to the request, if possible, returning one of images stored in the image pool S17, which has the first desired attribute; otherwise, an image having the first desired attribute, which is transformed from one of the images of the captured frame selected in the image pool S17 is returned and added into the image pool S17. The selected image is closest to the requested image among others in view of the first attribute.

In step S216, a value or score of the first feature for the captured frame is calculated using the returned working image. The calculated score is stored in the score register S15.

In step S221, for a second feature such as stability, motion activity or color difference, it is determined whether the current frame is the first frame of the video sequence. If so, the flow goes to step S18 to skip the extraction steps; otherwise, the flow goes to step S222.

In step S222, two raw images respectively of a previous and the currently captured frame are stored in the image pool S17.

In step S223, the extraction procedure makes a request for two images respectively of the previous and currently captured frames having a desired attribute such as a resolution of 360×240.

In step S224, in response to the request and for each of the two requested images, if possible, one of the images of the corresponding frame having the second desired attribute in the image pool S17 is returned; otherwise, an image having the second desired attribute, which is transformed from one of the images of the corresponding frame selected in the image pool S17 is returned and added into the image pool S17. The selected image is closest to the requested image among others in view of the second attribute.

In step S225, a value or score of the second feature for the captured frame is calculated using the two returned working images.

In the previous embodiment, only two extraction procedures respectively for the first and second features are illustrated. However, the weights or even number of the features to be extracted may be determined by user-input so that the abstraction result can be different. This is advantageous to accurate mapping of user cognition in the automated abstraction process.

In conclusion, the present invention provides a method of video abstraction adopting multi-resolution feature extraction, wherein the working image conforming with a corresponding requirement for extraction of a feature is obtained only by making a request to an image pool manager, rather than by the extraction procedure itself. This new video abstraction method shows high efficiency and flexibility in feature extraction.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

1. A method for feature extraction comprising the steps of:
storing into a storage area at least a raw image of a frame in a video sequence;
making a request for an image of the frame having a desired attribute;
in response to the request,
if possible, returning one of the images of the frame having the desired attribute in the storage area;
otherwise, returning and adding in the storage area an image having the desired attribute, which is transformed from one of the images of the frame in the storage area; and
calculating a value of a feature of the frame using the returned image.

2. The method as claimed in claim 1, wherein the attribute is image resolution.

3. The method as claimed in claim 1, wherein the feature is averaged color, averaged brightness or skin ratio.

4. The method as claimed in claim 1, wherein the feature is determined by user-input.

5. The method as claimed in claim 1, wherein the image in the storage area selected to be transformed to the returned image has the attribute of a value closest to the desired value.

6. The method as claimed in claim 1 further comprising the steps of:
storing into the storage area a raw image of a previous frame in the video sequence;
making a second request for an image of the previous frame having the desired attribute; and
in response to the second request,
if possible, returning one of the images of the previous frame having the desired attribute in the storage area;
otherwise, returning and adding into the storage area an image having the desired attribute, which is transformed from one of the images of the previous frame in the storage area;
wherein the feature is calculated further using the returned image for the second request.

7. The method as claimed in claim 6, wherein the attribute is image resolution.

8. The method as claimed in claim 6, wherein the feature is stability, motion activity or color difference.

9. The method as claimed in claim 6, wherein the feature is determined by user-input.

10. The method as claimed in claim 6, wherein the image in the storage area selected to be transformed to the returned image has the attribute of a value closest to the desired value.

11. A method for video abstraction comprising the steps of:
a) capturing one of the frames from a video sequence;
b) applying scene detection to the captured frame;
c) extracting features of the captured frame by the steps of:
c1) storing a raw image of the captured frame in a storage area;
c2) for a selected one of the features, making a request for an image of the captured frame having a desired attribute;
c3) in response to the request,
if possible, returning one of the images of the captured frame having the desired attribute in the storage area;
otherwise, returning and adding into the storage area an image having the desired attribute, which is transformed from one of the images of the captured frame in the storage area;
c4) calculating a value of the selected feature for the captured frame using the returned image; and
c5) repeating the steps c2˜c4 until all the features are selected;
d) repeating the steps a˜c until a transition from a current to a next scene is detected in the step b or all the frames are captured;
e) calculating a score of the current scene using the values of the features of the frames therein;
f) repeating the steps a˜e until all the frames are captured; and
g) selecting the scenes according to the scores thereof and composing the selected scenes to yield an abstraction result.

12. The method as claimed in claim 11, wherein the attribute is image resolution.

13. The method as claimed in claim 11, wherein the feature extraction further comprises the step of:
c0) implementing the steps c1˜c4 only if the captured frame is determined as a representative frame according to the scene detection result, otherwise, setting the value of the selected feature of the captured frame the same as that of a representative frame previously determined;
wherein the step c0 in addition to the steps c2˜c4 is repeated in the step c5.

14. The method as claimed in claim 13, wherein the features are averaged color, averaged brightness and skin ratio.

15. The method as claimed in claim 11, wherein the features are determined by user-input.

16. The method as claimed in claim 11, wherein the image in the storage area selected to be transformed to the returned image has the attribute of a value closest to the desired value.

17. The method as claimed in claim 11, wherein the feature extraction further comprises the steps of:
c6) storing into the storage area a raw image of a previous frame;
c7) for the selected feature, making a second request for an image of the previous frame having the desired attribute; and
c8) in response to the second request,
if possible, returning one of images of the previous frame having the desired attribute in the storage area;
otherwise, returning and adding into the storage area an image having the desired attribute, which is transformed from one of the images of the previous frame in the storage area;
wherein the value of the selected feature is calculated further using the returned image for the second request in the step c4 and the steps c6˜c8 additional to the steps c2˜c4 are repeated in the step c5.

18. The method as claimed in claim 17, wherein the attribute is image resolution.

19. The method as claimed in claim 17, wherein the features are stability, motion activity and color difference.

20. The method as claimed in claim 17, wherein the feature is determined by user-input.

21. The method as claimed in claim 17, wherein the image in the storage area selected to be transformed to the returned image has the attribute of a value closest to the desired value.

22. A method for video abstraction comprising the steps of:
a) capturing one of the frames from a video sequence;
b) applying scene detection to the captured frame;
c) extracting a first feature of the captured frame by the steps of:
c0) implementing steps c1˜c4 only if the captured frame is determined as a representative frame according to the scene detection result, otherwise, setting the value of the first feature of the captured frame the same as that of a representative frame previously determined,
c1) storing a raw image of the captured frame in a storage area;
c2) making a request for an image of the captured frame having a first desired attribute;
c3) in response to the request,
if possible, returning one of the images of the captured frame having the first desired attribute in the storage area;
otherwise, returning and adding the storage area an image having the first desired attribute, which is transformed from one of the images of the captured frame in the storage area; and
c4) calculating a value of the first feature for the captured frame using the returned image;
d) extracting a second feature of the captured frame by the steps of:
d0) storing into the storage area two raw images respectively of a previous and the currently captured frame;
d1) making a request for two images respectively of the previous and currently captured frames having a second desired attribute; and
d2) in response to the request and for each of the two requested images,
if possible, returning one of images of the corresponding frame having the second desired attribute in the storage area;
otherwise, returning and adding to the storage area an image having the second desired attribute, which is transformed from one of the images of the corresponding frame in the storage area; and
d3) calculating a value of the second feature for the captured frame using the two returned images;
e) repeating the steps a˜d until a transition from a current to a next scene is detected in the step b or all the frames are captured;
f) calculating a score of the current scene using the values of the features of the frames therein;
g) repeating the steps a˜f until all the frames are captured; and
h) selecting the scenes according to the scores thereof and composing the selected scenes to yield an abstraction result.

23. The method as claimed in claim 22, wherein the first feature is averaged color, averaged brightness or skin ratio.

24. The method as claimed in claim 22, wherein the second feature is stability, motion activity or color difference.

25. The method as claimed in claim 22, wherein the attribute is image resolution.

26. The method as claimed in claim 22, wherein the first and second features are determined by user-input.

27. The method as claimed in claim 22, wherein the image in the storage area selected to be transformed to the returned image has the attribute of a value closest to the first or second desired value.
